(19) United States
(12) Patent Application Publication
(10) Pub. No.: US 2025/0385602 A1
(43) Pub. Date: Dec. 18, 2025

(54) Power controller and power conversion device having the same

(71) Applicant: LX SEMICON CO., LTD., Daejeon (KR)

(72) Inventors: Won Suk JANG, Daejeon (KR); Xuan Dien DO, Daejeon (KR); Chang Jin JEONG, Daejeon (KR)

(73) Assignee: LX SEMICON CO., LTD., Daejeon (KR)

(21) Appl. No.: 18/876,043

(22) PCT Filed: Jun. 16, 2023
(86) PCT No.: PCT/KR2023/008392

§ 371 Date: Dec. 17, 2024

(30) Foreign Application Priority Data
Jun. 17, 2022 (KR) 10-2022-0074319

(51) Int. Cl. H02M 1/44; H02M 7/06

(52) U.S. Cl. CPC H02M 1/44; H02M 7/06

(57) ABSTRACT

The embodiment relates to the control of a power conversion device, and can provide a control technique for reflecting an AC component of an error signal into a S-signal to cancel each other in order to minimize the influence of noise flowing into a feedback loop.

According to the embodiment, the influence of noise flowing into a feedback loop of a power conversion device on the output voltage of the power conversion device can be minimized, and the output voltage of the power conversion device can be stably regulated.

### TECHNICAL FIELD

The embodiment relates to a power conversion device. More specifically, it relates to control of a power conversion device.

### BACKGROUND ART

A display device includes a power conversion device. The power conversion device mainly performs the function of converting and supplying system power supplied from a commercial power source or a battery to match the characteristics of components included in the display device. For example, when the voltage of the system power and the operating voltage of the components are different, the power conversion device converts the voltage of the system power and supplies it to each component.

The power conversion device includes a feedback loop for regulating the output voltage supplied to the components to a certain size. If noise is introduced into this feedback loop, the output voltage may not be regulated to a certain size and may fluctuate.

Since the display device generates a lot of noise during the pixel driving process, there is a high possibility that noise will be introduced into the feedback loop of the power conversion device. Accordingly, various studies are being conducted to minimize the effects of noise in power conversion devices.

### DETAILED DESCRIPTION OF THE INVENTION

### Technical Problem

In this context, the purpose of the embodiment is to provide a technology for minimizing the influence of noise in a power conversion device. In particular, the purpose of the embodiment is to provide a technology for minimizing the influence of noise flowing into the feedback loop of the power conversion device on the output voltage of the power conversion device.

The technical problem of the embodiment is not limited to what is described in this item, and includes what can be understood through the description of the invention.

### Technical Solution

In order to achieve the above-mentioned purpose, according to one aspect of the embodiment, a power controller includes an error signal generator configured to generate an error signal according to the difference between a sensing voltage and a reference voltage of a power conversion device including a power semiconductor; a SAW signal generator configured to generate a first SAW signal; a SAW signal modulator configured to generate a second SAW signal by reflecting an alternating current (AC) component of the error signal to the first SAW signal to; and a Power Width Modulation (PWM) signal generator configured to generate a PWM signal to control the power semiconductor by comparing the second SAW signal and the error signal.

According to another aspect of the embodiment, a power conversion device includes a power semiconductor; and a power controller configured to supply a gate signal to a gate of the power semiconductor to regulate the output of the power conversion device, and including a capacitor, wherein the capacitor is arranged between a line of an error signal generated according to a difference between a sensing voltage and a reference voltage of the power conversion device and a line of a SAW signal.

The output of the power conversion device can be supplied to a display driving device that drives pixels at a constant frame rate.

### Effect of the Invention

As described above, according to the embodiment, the influence of noise in the power conversion device can be minimized. In particular, according to the embodiment, the influence of noise introduced into the feedback loop of the power conversion device on the output voltage of the power conversion device can be minimized, and the output voltage of the power conversion device can be stably regulated.

Additional scope of applicability of the embodiment will become apparent from the detailed description below. However, since various changes and modifications within the spirit and scope of the embodiment can be clearly understood by those skilled in the art, it should be understood that the detailed description and specific embodiments such as the preferred embodiment are given only as examples.

### BRIEF DESCRIPTION OF THE DRAWINGS

FIG. 1 is a configuration diagram of a display device according to one embodiment.

FIG. 2 is a configuration diagram of a power conversion device according to one embodiment.

FIG. 3 is a configuration diagram of a controller according to one embodiment.

FIG. 4 is a main waveform diagram of a controller without a signal modulator.

FIG. 5 is a diagram illustrating that an AC component of an error signal is reflected in a signal according to one embodiment.

FIG. 6 is a main waveform diagram of a controller with a signal modulator according to one embodiment.

FIG. 7 is a configuration diagram of a signal generator and a signal modulator according to one embodiment.

FIG. 8 is a diagram illustrating an example in which a buffer is further included in a controller according to one embodiment.

The sizes, shapes, and numbers of the components shown in the drawings may differ from the actual ones. In addition, even if the same components are depicted in different sizes, shapes, and values between drawings, this is only an example in the drawings, and the same components may have the same sizes, shapes, and values between drawings.

### Best Mode

Hereinafter, the embodiments disclosed in this specification will be described in detail with reference to the attached drawings. Regardless of the drawing symbols, identical or similar components will be assigned the same reference numbers and redundant descriptions thereof will be omitted. The suffixes ‘module’ and ‘part’ used for components in the following description are assigned or used interchangeably in consideration of the ease of writing the specification, and do not have distinct meanings or roles in themselves. In addition, the attached drawings are intended to facilitate easy understanding of the embodiments disclosed in this specification, and the technical ideas disclosed in this specification are not limited by the attached drawings. In addition, when an element such as a layer, region, or substrate is mentioned as existing ‘on’ another element, this includes that it may be directly on the other element or that other intermediate elements may exist between them.

Hereinafter, a SAW signal generator may be used interchangeably with a ramp signal generator. A SAW signal modulator may be called an Alternative Current (AC) component synthesizer, an AC component adder, etc. A PWM signal generator may be called a pulse signal generator.

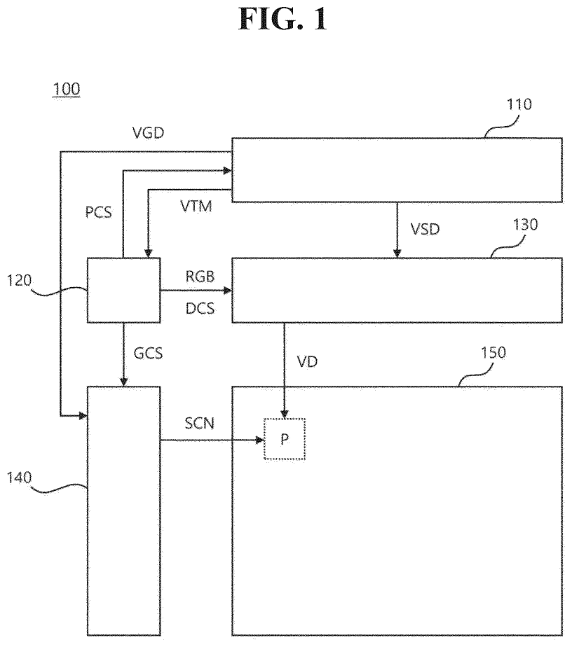

FIG. 1 is a configuration diagram of a display device according to one embodiment.

Referring to FIG. 1, a display device 100 according to one embodiment may include a power conversion device 110, a timing controller 120, a source driver 130, a gate driver 140, and a display panel 150. A display driving device may be configured by at least one of the timing controller 120, the source driver 130, and the gate driver 140.

The power conversion device 110 may supply power to the timing controller 120, the source driver 130, the gate driver 140, and the display panel 150.

The power conversion device 110 can supply a first driving voltage (VTM) to the timing controller 120. The timing controller 120 can perform operations on image data using the first driving voltage (VTM).

The power conversion device 110 can supply a second driving voltage (VSD) to the source driver 130. The source driver 130 can drive pixels (P) arranged on the display panel 150 using the second driving voltage (VSD).

The power conversion device 110 can supply a third driving voltage (VGD) to the gate driver 140. The gate driver 140 can generate a scan signal (SCN) using the third driving voltage (VGD).

The power conversion device 110 can supply power suitable for the display panel 150 depending on the type of the display panel 150. If the display panel 150 is a Liquid Crystal Display (LCD) panel, the power conversion device 110 can supply a common voltage to a common electrode disposed on the display panel 150.

If the display panel 150 is an Organic Light Emitting Diode (OLED) panel, the power conversion device 110 can supply a base voltage to the cathode electrodes of the OLEDs disposed on the display panel 150 and can supply a pixel driving voltage to the anode electrodes of the OLEDs.

The timing controller 120 can process image data received from an external device to be suitable for the characteristics of the display panel 150 and transmit the processed image data (RGB) to the source driver 130. The timing controller 120 can transmit a data control signal (DCS) to the source driver 130 to control, set, and/or manage the source driver 130.

The timing controller 120 can transmit a gate control signal (GCS) to control the scan timing for the display panel 150 to the gate driver 140. The timing controller 120 can transmit a power control signal (PCS) to control the power conversion device 110 to the power conversion device 110.

The image data (RGB), the data control signal (DCS), the gate control signal (GCS), and the power control signal (PCS) can be transmitted in frames. For example, when the frame rate is 120 Hz, each signal can be transmitted once every 1/120 seconds. For example, if the frame rate is 240 Hz, each signal may be transmitted once every 1/240 seconds. This periodic signal transmission by the timing controller 120 may be a source of noise to the power conversion device 110.

The source driver 130 can convert the grayscale value of each pixel (P) included in the image data (RGB) into a data voltage (VD) and supply it to the corresponding pixel (P) through each of the plurality of data lines on the display panel 150. The data voltage (VD) can include an analog data voltage.

The source driver 130 can transmit the data voltage (VD) in line units. Here, the line can be one of the plurality of gate lines on the display panel 150.

For example, the gate driver 140 can select one of the plurality of gate lines using a scan signal (SCN). That is, a specific gate line can be selected by supplying the scan signal (SCN) generated by the gate driver 140 to one of the plurality of gate lines. In response to the scan signal (SCN) supplied to a specific gate line, the thin film transistor of each of the pixels (P) connected to a specific gate line can be turned on. Therefore, the gate line selection can be determined by the scan signal (SCN) supplied by the gate driver 140.

For example, the source driver 130 can simultaneously supply data voltages (VD) to the pixels (P) connected to a specific gate line.

The supply of the data voltage (VD) can consume a relatively large amount of power. This large amount of power consumption can occur on a line basis and can be recognized as a noise source by the power conversion device 110.

These various noises in the display device 100 can be introduced into the feedback loop of the power conversion device 110. Accordingly, the power conversion device 110 according to one embodiment includes a controller to minimize the influence of these noises on the regulation of the output voltage. Here, the output voltage may be a first driving voltage (VTM), a second driving voltage (VSD), a third driving voltage (VGD), etc.

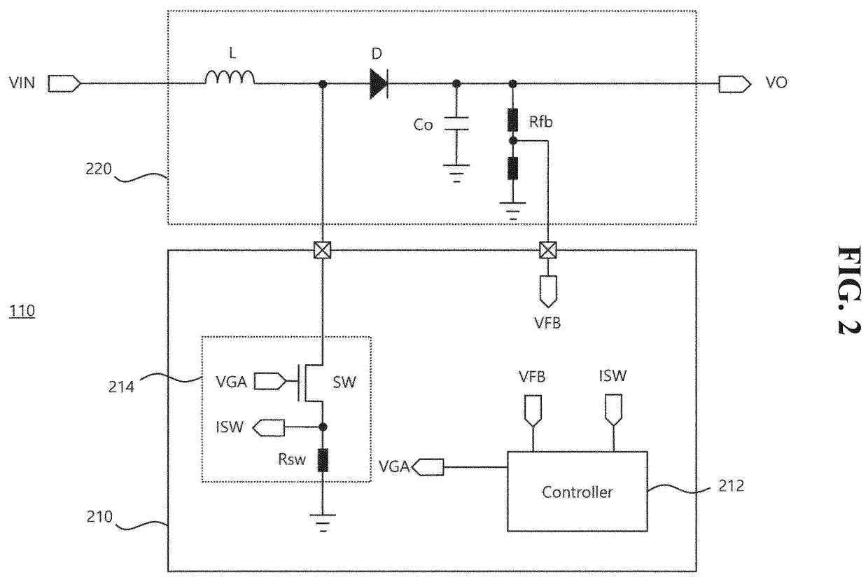

FIG. 2 is a configuration diagram of a power conversion device according to one embodiment.

Referring to FIG. 2, the power conversion device 110 may include a power management device 210 and a power stage 220. The power management device 210 may be formed as a power management integrated circuit (Power Management Integrated Circuit) integrated in an IC form.

The power conversion device 110 may include an inductor (L), an output capacitor (Co), a first power semiconductor (SW), a second power semiconductor (D), etc.

Large passive components such as the inductor (L) and the output capacitor (Co) may be placed in the power stage 220, and the first power semiconductor (SW) and the second power semiconductor (D) that may be included in the integrated circuit may be built into the power management device 210. Alternatively, the second power semiconductor (D) may be placed in the power stage 220 as needed.

The first power semiconductor (SW) may be a transistor such as a MOSFET (Metal Oxide Semiconductor Field Effect Transistor), and the second power semiconductor (D) May be a diode. Depending on the embodiment, the second power semiconductor (D) may also be a controllable transistor, and in this case, the power conversion device 110 may be called a synchronous type.

In the following embodiments, unless otherwise stated, the power semiconductor may mean the first power semiconductor (SW) as a transistor.

Depending on the arrangement and connection relationship of the inductor (L), the output capacitor (Co), the first power semiconductor (SW), and the second power semiconductor (D), the power conversion device 110 may be called a buck converter, a boost converter, a buck-boost converter, a flyback converter, etc., but the embodiment is not limited to these specific types of converters. The embodiment can be applied to any device that converts power using a power semiconductor. For convenience of explanation, a boost converter is described below as an example.

When the first power semiconductor (SW) is turned on, an input voltage (VIN) is applied to the inductor (L), and electric energy is stored in the inductor (L). When the first power semiconductor (SW) is turned off, the electric energy stored in the inductor (L) can be stored in the output capacitor (Co) through the second power semiconductor (D), so that an output voltage (VO) can be formed. At this time, the size of the output voltage (VO) can be adjusted according to the turn-on time of the first power semiconductor (SW).

The power management device 210 may include a controller 212 and a switch circuit 214. The switch circuit 214 may include a first power semiconductor (SW). The controller 212 may periodically turn on and off the first power semiconductor (SW) of the switch circuit 214, thereby regulating the output voltage (VO).

The controller 212 may generate a gate signal (VGA) of the first power semiconductor (SW) using the sensing voltage (VFB) and the sensing current (ISW) of the power conversion device 110. The gate signal (VGA) may be called a regulation control signal, a power control signal, an output control signal, etc.

The sensing voltage (VFB) may be generated through at least two feedback resistors (Rfb) arranged at the output terminal of the power stage 220 and connected in series with each other. The output voltage (VO) may be voltage-divided by these two or more feedback resistors (Rfb), and the voltage-divided voltage may be detected as the sensing voltage (VFB). For example, the sensing voltage (VFB) may be detected from a node between adjacent feedbacks (Rfb). The sensing current (ISW) may be generated through a sensing resistor (Rsw) connected in series with the first power semiconductor (SW). That is, the sensing current (ISW) may be detected from a node between the first power semiconductor (SW) and the sensing resistor (Rsw). The sensing voltage (VFB) may correspond to the output voltage (VO) of the power conversion device 110. The sensing current (ISW) may correspond to the current flowing in the inductor (L) and the output current of the power conversion device 110.

The controller 212 may regulate the output voltage (VO) of the power conversion device 110 to a certain size using the sensing voltage (VFB). The controller 212 may regulate the output current of the power conversion device 110 to a certain size using the sensing current (ISW). Here, regulation may mean that the output voltage (VO) or the sensing current (ISW) is adjusted, varied, modulated, or controlled.

The controller 212 may regulate the output voltage (VO) of the power conversion device 110 using the sensing voltage (VFB) as voltage control. The controller 212 regulating the output of the power conversion device 110 using the sensing current (ISW) and the sensing voltage (VFB) can be called current control. For convenience of explanation, the following description focuses on an example of voltage control.

Meanwhile, the sensing voltage (VFB) can be detected through a feedback resistor (Rfb) placed at the output terminal of the power conversion device 110. Meanwhile, if noise occurs in the load on the output side connected to the output voltage (VO), the noise can be introduced into the sensing voltage (VFB) through the feedback resistor (Rfb).

Although not shown in the drawing, noise may be introduced through other paths. For example, noise may be introduced through a control loop compensation circuit included in the controller 212.

A controller according to one embodiment may include components for removing the influence of noise introduced from the outside, for example, noise introduced through a sensing voltage (VFB) or through a control loop compensation circuit. In this case, the controller May be included in the power management device 210 as shown in FIG. 2 or may be provided separately without being included in the power management device 210. In this case, the controller may be called a power controller. In the following description, unless otherwise specified, the controller may mean a power controller.

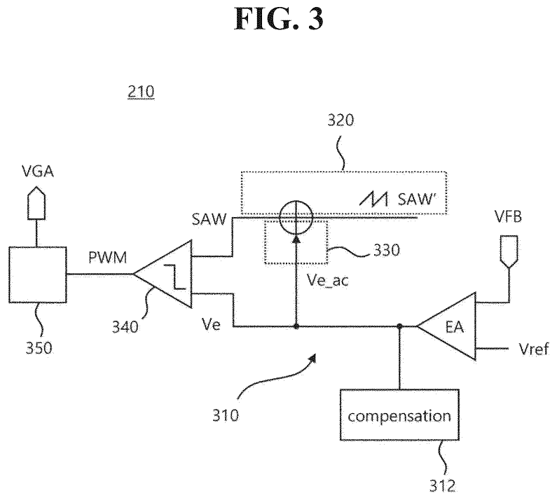

FIG. 3 is a configuration diagram of a controller according to one embodiment.

Referring to FIGS. 2 and 3, the controller 212 may include an error signal generator 310, a SAW signal generator 320, a SAW signal modulator 330, a PWM signal generator 340, and a gate controller 350. The SAW signal generator 320 and the SAW signal modulator 330 may be called a first SAW signal generator and a second SAW signal generator, respectively, but are not limited thereto.

The error signal generator 310 may generate an error signal (Ve) according to the difference between the sensing voltage (VFB) detected from the output terminal of the power conversion device, specifically, the power stage 220, and the reference voltage (Vref).

The error signal generator 310 may include an error amplifier (EA), a control loop compensation circuit 312, etc.

The error amplifier (EA) can amplify and output the difference between the sensing voltage (VFB) and the reference voltage (Vref). The amplification ratio of the error amplifier (EA) can affect the control loop gain. By adjusting the amplification ratio of the error amplifier (EA), the control loop gain can be increased or decreased.

The output of the error amplifier (EA) may be transmitted to the control loop compensation circuit 312. The control loop compensation circuit 312 may be a circuit for compensating the control loop gain. For example, the control loop compensation circuit 312 may include a plurality of capacitors to form a state. For example, the control loop compensation circuit 312 may configure a Proportional Integral Derivative (PID) control circuit using a plurality of capacitors and a plurality of resistors.

The output voltage of the output terminal of the error amplifier (EA) connected to the control loop compensation circuit 312 may be an error signal (Ve). Alternatively, the output terminal of the error amplifier (EA) may be connected to a buffer, etc. described below, and the output voltage of the output terminal of the buffer may be an error signal (Ve).

The SAW signal generator 320 may generate a SAW signal (SAW). The Saw signal can be named because its waveform resembles the shape of a saw tooth. In contrast, a signal that is compared with an error signal (Ve) to generate a PWM signal is also called a Saw signal.

The PWM signal generator 340 can generate a PWM signal (PWM) to control a power semiconductor (SW) by comparing the SAW signal (SAW) and the error signal (Ve).

The gate controller 350 can generate a gate signal (VGA) according to the PWM signal (PWM) and supply the gate signal (VGA) to the power semiconductor (SW).

Meanwhile, as described above, noise can be introduced into the sensing voltage (VFB), and this noise can be transmitted to the error signal (Ve) through the error amplifier (EA).

Or, noise may be introduced through the control loop compensation circuit 312, and this noise may be transmitted as an error signal (Ve) through the error amplifier (EA).

If the sensing voltage (VFB) or the control loop compensation circuit 312 has a terminal exposed to the outside of the integrated circuit, the possibility of such noise introduction is high, but even if this is not the case, noise may be introduced as an error signal (Ve) through various paths.

In the case of normal operation, when the power conversion device 110 reaches a stable state, the error signal (Ve) may substantially have a form of direct current (DC). However, if noise is introduced to this error signal (Ve), i.e., when it operates abnormally, the error signal (Ve) may appear in the form of alternating current (AC).

The signal modulator 330 can reflect the AC component (Ve_ac) of the error signal (Ve) to the SAW signal in order to minimize the influence of noise. In this way, the error signal (Ve) can include the AC component (Ve_ac) and the SAW signal can include the AC component (Ve_ac). The AC component (Ve_ac) included in the error signal (Ve) and the AC component (Ve_ac) included in the SAW signal can be canceled out by the PWM signal generator 340. Accordingly, the PWM signal (PWM) is not affected. In other words, since the PWM signal (PWM) does not include the AC component (Ve_ac), noise is not included in the gate signal (VGA) generated based on the PWM signal (PWM).

In order to understand the function of this SAW signal modulator 330, the main waveforms in the controller without the SAW signal modulator 330 and the main waveforms in the controller with the SAW signal modulator 330 are compared.

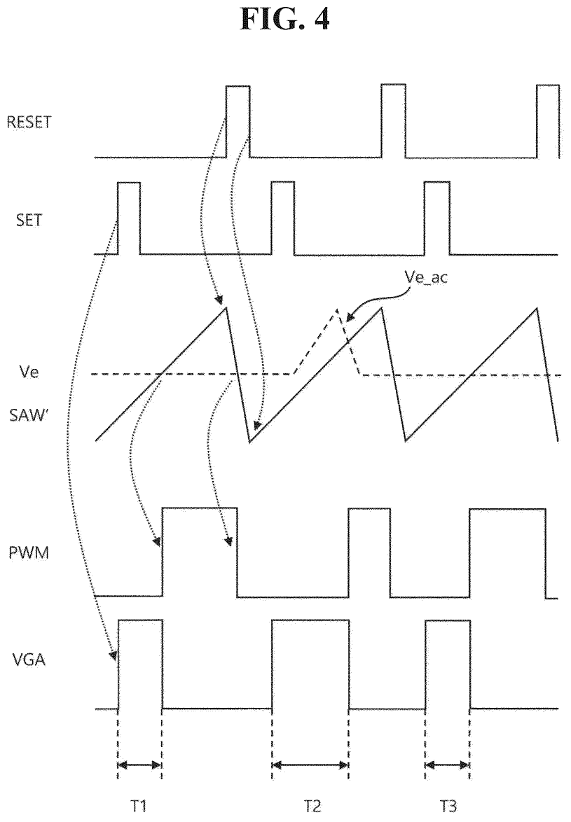

FIG. 4 is a main waveform diagram of a controller without the SAW signal modulator.

Referring to FIG. 4, the rising edge of the gate signal (VGA) can be formed according to the set signal (SET). The falling edge of the gate signal (VGA) can be formed according to the rising edge of the PWM signal (PWM). The set signal (SET) occurs at regular intervals, and this interval is also called a switching period. The period in which the gate signal (VGA) has a high level (hereinafter referred to as the ‘on period’) becomes the turn-on time of the power semiconductor (SW), and the output of the power conversion device is controlled according to the proportion of the on period of the gate signal (VGA) in the switching period.

In the case of normal operation, i.e., when the output is stable, the on-period of the gate signal (VGA) can be maintained constant in each switching cycle. However, as exemplified in the second switching cycle of FIG. 4, in the case of abnormal operation, i.e., when noise is introduced into the error signal (Ve), the on-period of the gate signal (VGA) can vary.

The falling edge of the gate signal (VGA) can be formed according to the rising edge of the PWM signal (PWM). The rising edge of the PWM signal (PWM) can occur at the moment when the SAW signal (SAW′) becomes greater than the error signal (Ve). For example, if the error signal (Ve) has a higher level than the SAW signal (SAW′), the PWM signal (PWM) can have a low level. For example, if the error signal (Ve) has a lower level than the SAW signal (SAW′), the PWM signal (PWM) can have a high level. According to this operation method, the rising edge of the PWM signal (PWM) can occur at each moment when the SAW signal (SAW′) becomes larger than the error signal (Ve).

Meanwhile, as in the second switching cycle illustrated in FIG. 4, when the error signal (Ve) includes an AC component (Ve_ac) due to noise, the moment when the SAW signal (SAW′) becomes larger than the error signal (Ve) can vary. Accordingly, the width of the ON period of the gate signal (VGA) also varies. As illustrated in FIG. 4, the width of the ON period (T1, T3) of the gate signal (VGA) in the first and third switching cycles without noise and the width of the ON period (T2) of the gate signal (VGA) in the second switching cycle with noise are different.

When the switching cycle starts, the SAW signal (SAW′) can gradually increase in level and then decrease at the rising edge of the reset signal (RESET). Next, the SAW signal (SAW′) may increase again at the falling edge of the reset signal (RESET). The falling edge of the reset signal (RESET) may be the start of each switching cycle. Specifically, the SAW signal (SAW′) may increase in the section between the falling edge of the first reset signal and the rising edge of the second reset signal adjacent to the first reset signal, and the SAW signal (SAW′) may decrease in the section between the rising edge of the second reset signal and the falling edge of the second reset signal.

Meanwhile, as illustrated in FIG. 3, the controller according to one embodiment may solve the above-described problem (FIG. 4) by reflecting the AC component (Ve_ac) of the error signal (Ve) into the SAW signal through the SAW signal modulator 330.

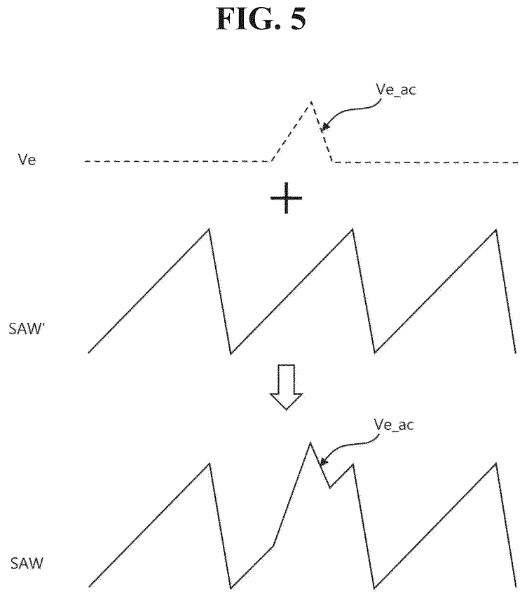

FIG. 5 is a diagram illustrating that the AC component of the error signal is reflected in the SAW signal in one embodiment.

Referring to FIG. 3 and FIG. 5, the controller can generate an original SAW signal (SAW′) and extract an AC component (Ve_ac) from the error signal (Ve). The controller can synthesize the extracted AC component (Ve_ac) with the generated original SAW signal (SAW′) to generate the SAW signal (SAW). Here, the synthesis may mean an addition operation.

Unlike the original SAW signal (SAW′), the SAW signal generated in this manner may further include an AC component (Ve_ac) corresponding to noise. Here, the original SAW signal (SAW′) and the SAW signal (SAW) may be called a first SAW signal and a second SAW signal, respectively, but are not limited thereto.

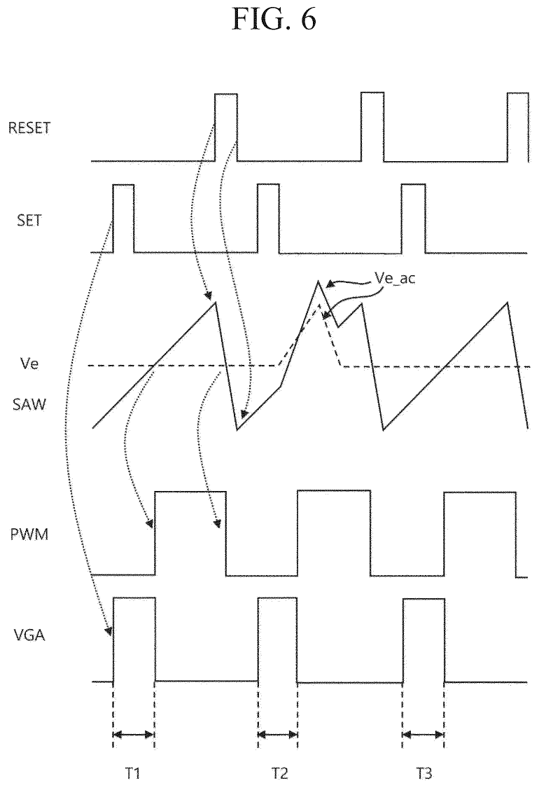

FIG. 6 is a main waveform diagram of a controller having a SAW signal modulator according to one embodiment.

Referring to FIG. 3 and FIG. 6, the rising edge of the gate signal (VGA) can be formed according to the set signal (SET). The falling edge of the gate signal (VGA) can be formed according to the rising edge of the PWM signal (PWM). The set signal (SET) can occur at regular intervals.

The falling edge of the gate signal (VGA) can be formed according to the rising edge of the PWM signal (PWM). The rising edge of the PWM signal (PWM) can occur at the moment when the SAW signal becomes greater than the error signal (Ve). For example, if the error signal (Ve) has a higher level than the SAW signal, the PWM signal (PWM) can have a low level. For example, if the error signal (Ve) has a lower level than the SAW signal, the PWM signal (PWM) can have a high level. According to this operation method, the rising edge of the PWM signal (PWM) can be generated whenever the SAW signal becomes larger than the error signal (Ve).

As described above, the AC component (Ve_ac) of the error signal (Ve) can be reflected in the SAW signal. In the case where the error signal (Ve) includes an AC component (Ve_ac) due to noise, such as in the second switching cycle illustrated in FIG. 6, the SAW signal can also include an AC component (Ve_ac) by the SAW signal modulator 330.

Both the error signal (Ve) and the SAW signal to be compared may include an AC component (Ve_ac) due to noise. In particular, as illustrated in FIG. 5, since the SAW signal is generated by synthesizing the AC component (Ve_ac) with the original SAW signal (SAW′), the waveform of the SAW signal may be larger than the intensity of the waveform of the original SAW signal (SAW′) by the amount of the AC component (Ve_ac) in the section where the AC component (Ve_ac) exists. Accordingly, even if noise is generated, it may be generated at an earlier point in time than the rising edge of the PWM signal (PWM). In other words, the point in time when the level of the SAW signal becomes higher than the level of the error signal (Ve) in the section where noise is generated may be brought forward. Accordingly, the width of the PWM signal (PWM) in the section where noise is generated can be substantially the same as the width of the PWM signal (PWM) in the section where noise is not generated. Accordingly, the widths of the on sections (T1, T2, T3) of the gate signal (VGA) in each switching cycle become substantially the same.

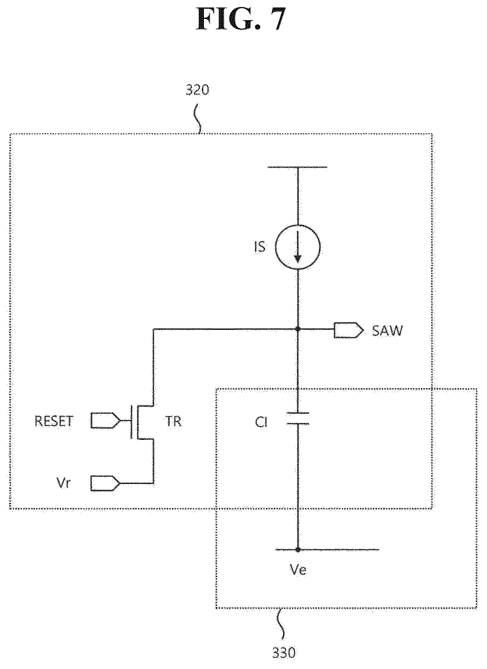

FIG. 7 is a configuration diagram of a signal generator and a signal modulator according to one embodiment.

Referring to FIGS. 2, 3, and 7, the signal generator 320 may include a current source (IS), an integrating capacitor (CI), and a reset switch (TR).

The current source (IS) and the integrating capacitor (CI) constitute a ramp signal generator. A current of a constant size from the current source (IS) may charge the integrating capacitor (CI). Accordingly, the voltage of the integrating capacitor (CI) may increase in the form of a ramp signal. When the reset switch (TR) is turned on, the voltage of the integrating capacitor (CI) may be reset to a reset voltage (Vr). The reset switch (TR) may be periodically turned on and then turned off by a reset signal (RESET). According to the cycle of this reset signal (RESET), the ramp signal generator (IS and CI) can periodically generate a ramp signal. According to this cycle, the integrating capacitor (CI) can be reset to a certain voltage.

The ramp signal generated by the ramp signal generator (IS and CI) can be the original SAW signal (refer to SAW′ of FIG. 3) illustrated in FIG. 3. The SAW signal generator 320 can generate a SAW signal using this ramp signal. Therefore, the SAW signal can be called a ramp signal.

In the ramp signal generator (IS and CI), the current source (IS) is connected to one side of the integrating capacitor (CI), and a line supplied with an error signal (Ve) can be connected to the other side of the integrating capacitor (CI).

The SAW signal modulator 330 can include an integrating capacitor (CI). The integral capacitor (CI) can function as a DC blocking capacitor. The SAW modulator 330 can reflect the AC component to the SAW signal through this DC blocking capacitor. Since the SAW signal is formed on one side of the DC blocking capacitor and the line to which the error signal (Ve) is supplied, i.e., the line connected to the output terminal of the error amplifier (EA), is connected to the other side of the DC blocking capacitor, the DC component of the error signal (Ve) is blocked by the DC blocking capacitor and only the AC component is reflected to the SAW signal.

As described above, the embodiment can be applied to current control as well as voltage control. When applied to current control, the SAW signal generator 330 can generate the SAW signal by synthesizing the sensing current (ISW) of the power converter 110 to the ramp signal.

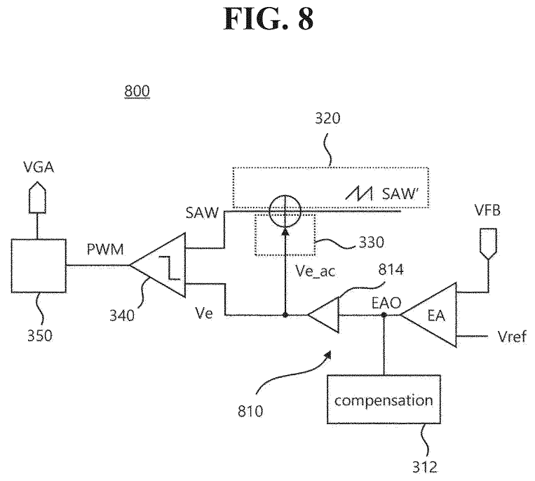

FIG. 8 is a drawing illustrating an example in which a buffer is further included in a controller according to one embodiment.

Referring to FIG. 8, the controller 800 may include an error signal generator 810, a SAW signal generator 320, a SAW signal modulator 330, a PWM signal generator 340, a gate controller 350, etc.

The error signal generator 810 may generate an error signal (Ve) according to the difference between the sensing voltage (VFB) and the reference voltage (Vref) of a power conversion device 110 including a power semiconductor (SW).

The error signal generator 810 may include an error amplifier (EA), a control loop compensation circuit 312, a buffer 814, etc.

The error amplifier (EA) can amplify and output the difference between the sensing voltage (VFB) and the reference voltage (Vref). The amplification ratio of the error amplifier (EA) can affect the control loop gain. The amplification ratio of the error amplifier (EA) can be adjusted to increase or decrease the control loop gain.

The output (EAO) of the error amplifier (EA) can be transmitted to the control loop compensation circuit 312. The control loop compensation circuit 312 can be a circuit for compensating the control loop gain. For example, the control loop compensation circuit 312 can include a plurality of capacitors to form a state. For example, the control loop compensation circuit 312 can configure a PID control circuit using a plurality of capacitors and a plurality of resistors.

An output voltage (EAO) is output from the output terminal of the error amplifier (EA) connected to the control loop compensation circuit 312, and this output voltage (EOA) can be generated as an error signal (Ve) through the buffer 814. That is, the error signal generator 810 amplifies and outputs the difference between the sensing voltage (VFB) and the reference voltage (Vref) using the error amplifier (EA), buffers the output voltage (EAO) of the error amplifier (EA) using the buffer 814, and generates an error signal (Ve) as the output of the buffer 814.

The buffer 814 can be a component with a large input impedance and a small output impedance. When the buffer 814 is used, the influence of the signal modulator 330 on the control loop gain can be minimized.

The SAW signal modulator 330 may be placed between the output side of the buffer 814 and the SAW signal generator 320. The control loop compensation circuit 312 may be connected to the input side of the buffer 814. The SAW signal modulator 330 may include a capacitor, for example, an integration capacitor (CI of FIG. 7), and the influence of the capacitor included in the SAW signal modulator 330 on the control loop compensation circuit may be minimized according to the separation by the buffer 814.

The SAW signal generator 320, the SAW signal modulator 330, the PWM signal generator 340, and the gate controller 350 have been described with respect to FIGS. 3 to 7, and thus a detailed description thereof will be omitted.

As described above, according to the embodiment, the influence of noise in the power conversion device may be minimized. In particular, according to the embodiment, the influence of noise introduced into the feedback loop of the power converter on the output voltage of the power converter can be minimized, and the output voltage of the power converter can be stably regulated.

The above detailed description should not be construed as limiting in all aspects, but should be considered as illustrative. The scope of the embodiment should be determined by a reasonable interpretation of the appended claims, and all changes within the equivalent scope of the embodiment are included in the scope of the embodiment.

What is claimed is:

1. A power controller comprising:
an error signal generator configured to generate an error signal according to the difference between a sensing voltage and a reference voltage of a power conversion device including a power semiconductor;
a SAW signal generator configured to generate a first SAW signal;
a SAW signal modulator configured to generate a second SAW signal by reflecting an alternating current (AC) component of the error signal to the first SAW signal to; and
a Power Width Modulation (PWM) signal generator configured to generate a PWM signal to control the power semiconductor by comparing the second SAW signal and the error signal.

2. The power controller of claim 1, further comprising a gate controller configured to generate a gate signal according to the PWM signal and supply the gate signal to the power semiconductor.

3. The power controller of claim 1, wherein the AC component reflector includes a Direct Current (DC) blocking capacitor, and is configured to reflect the AC component to the first SAW signal through the DC blocking capacitor.

4. The power controller of claim 1, wherein the SAW signal generator includes a ramp signal generator that periodically generates a ramp signal as the first SAW signal, and
wherein the SAW signal modulator is configured to generate the second SAW signal using the ramp signal.

5. The power controller of claim 4, wherein the ramp signal generator includes a current source and an integrating capacitor, and
wherein the current source is connected to one side of the integrating capacitor, and the other side of the integrating capacitor is connected to a line to which the error signal is supplied.

6. The power controller of claim 4, wherein the integrating capacitor is periodically reset to a constant voltage.

7. The power controller of claim 4, wherein the SAW signal generator is configured to generate the first SAW signal by synthesizing the sensing current of the power conversion device with the ramp signal.

8. The power controller of claim 1, wherein the error signal generator includes an error amplifier configured to amplify and output the difference between the sensing voltage and the reference voltage, and a buffer configured to buffer the output of the error amplifier, and
wherein the output of the buffer is generated as the error signal.

9. The power controller of claim 8, wherein the SAW signal modulator is arranged between an output side of the buffer and the SAW signal generator.

10. The power controller of claim 9, wherein the error signal generator further includes a control loop compensation circuit connected to an input side of the buffer.

11. The power controller of claim 2, wherein the gate controller is configured to form a rising edge of the gate signal according to the set signal and form a falling edge of the gate signal according to the rising edge of the PWM signal.

12. The power controller of claim 1, wherein the power conversion device is a buck converter or a boost converter including two power semiconductors.

13. A power conversion device comprising:
a power semiconductor; and
a power controller configured to supply a gate signal to a gate of the power semiconductor to regulate the output of the power conversion device, and including a capacitor,
wherein the capacitor is arranged between a line of an error signal generated according to a difference between a sensing voltage and a reference voltage of the power conversion device and a line of a SAW signal.

14. The power conversion device of claim 13, wherein the power controller is configured to generate a first SAW signal using a current source and the capacitor, and wherein one side of the capacitor is connected to the current source, and the other side of the capacitor is connected to the line of the error signal.

15. The power conversion device of claim 14, wherein the power controller is configured to generate the first SAW signal by synthesizing a voltage on one side of the capacitor and a sensing current of the power conversion device.

16. The power conversion device of claim 14, wherein the power controller includes:
an error amplifier configured to amplify and output the difference between the sensing voltage and the reference voltage, and
a buffer configured to buffer the output of the error amplifier, and
wherein the output of the buffer is generated as the error signal.

17. The power conversion device of claim 16, wherein the capacitor is arranged between the line formed on an output side of the buffer and the line of the SAW signal.

18. The power conversion device of claim 13, wherein a control loop compensation circuit is connected to the line of the error signal.

19. The power conversion device of claim 13, wherein the output of the power conversion device is supplied to a display driving device that drives pixels at a constant frame rate.

20. The power conversion device of claim 13, wherein the capacitor includes a DC blocking capacitor that blocks a DC component and transmits an AC component.
